(19) United States
(12) Patent Application Publication
(10) Pub. No.: US 2013/0133504 A1
(43) Pub. Date: May 30, 2013

(54) ISOLATION RINGS FOR USE WITH MUSICAL INSTRUMENTS AND EQUIPMENT

(71) Applicant: Akito TAKEGAWA, Chiba (JP)

(72) Inventor: Akito TAKEGAWA, Chiba (JP)

(21) Appl. No.: 13/305,046

(22) Filed: Nov. 28, 2011

(51) Int. Cl. G10D 13/02

(52) U.S. Cl. 84/421

(57) ABSTRACT

A resilient isolation ring member is provided for reducing a transfer of energy from a percussion instrument to a support surface supporting a percussion instrument. The isolation ring member comprises a donut-shaped main body having a top surface and a bottom surface; and a central aperture provided in the donut-shaped main body, wherein the central aperture provided in the donut-shaped main body defines an hour-glass opening in the main body. The hour-glass opening is preferably tapered to have a smallest diameter at a central portion of the main body and larger diameters at a top and a bottom of the body. The combination of a support foot for a percussion instrument and a resilient isolation ring member reduces a transfer of energy from the percussion instrument to a support surface supporting the percussion instrument.

### BACKGROUND OF THE INVENTION

The present invention relates to an isolation ring for use with a variety of musical instruments including but not limited to cymbal stands, high hat stands, bass drums, drum racks, etc. that minimizes the transfer of energy from the instrument to the floor or stage.

### DESCRIPTION OF RELATED ART

A resilient foot is typically used at the bottom ends of legs supporting musical equipment, such as cymbal stands, high hat stands, bass drums, drum racks, etc. Often, an endpin is used with the resilient foot of the musical instrument in order to provide stability when playing the instrument. The endpin, typically made of steel, is placed at the bottom of the instrument so that the instrument is stabilized by the endpin. However, use of the endpin causes a variety of problems. First, instrument suspension devices detract from the resonance of the instrument and. fail to minimize the transfer of energy from the instrument to the floor. Second, the endpin becomes dull due to constant contact with the floor. Third, the endpin may damage the floor surface due to its steel tip or be unstable and slide on very hard surfaces. Due to these problems associated with conventional feet and endpins, floor protectors were developed.

A typical floor protector for a cymbal or drum stand consists of a spongy rubber material which surrounds a foot. The foot receives and holds the tip of the endpin. However, the typical floor protector has several drawbacks because of the design and the materials used. See FIG. 4c for an example of a conventional spongy rubber floor protector.

In addition, a typical floor protector for a bass drum is a piece of carpet placed under the bass drum. Similar to floor protectors for other instruments, the floor protector for the bass drum is bulky, easily destroyed, and not aesthetically pleasing.

By way of example, FIG. 1 shows a prior art high hat stand which is supported by legs 41. It has a lower fixed cymbal 45 and an upper movable cymbal 46 at the top of the support 42. The upper movable cymbal 46 oscillates up and down through the operation of a foot pedal 50 at the bottom of the stand. There is a support base 43, an inner tube 44 that is adjustable in height inside the tube support 42 and that carries the lower cymbal 45, an operating rod 47 for the upper cymbal and a ground engaging member 48 below. The high hat stand sometimes moves away from the performer, especially as the weight of the cymbals 45 and 46 increases, and due to the operation of the pedal 50 during a performance.

To prevent such movement, a cap 49 is fitted to the tip of each leg 41. In some instances, a spike tip is provided at the bottom of the cap or foot 49 for preventing movement of the high hat stand. For example, FIG. 2 is a prior art arrangement with a reversible rubber/spiked foot member. In this design, a drumkey bolt ‘k’ is loosened and a spike tip ‘t’ is rotated downward. FIG. 3 illustrates a further alternate prior art arrangements with rotatable rubber/spike tip foot members. With these designs, a main body member carries both a rubber member and a spike tip member, The main body is rotated relative to the leg and fastened in place. FIGS. 4a and 4b illustrate alternate prior art embodiment for a rubber/spiked foot member where the spike tip “t” is retractable.

The various musical instrument foot members suffer however from the drawback that the transfer of energy from the musical instrument to the floor detracts from the resonance of the musical instrument. The need therefore exists for an improved resonance isolation system for use with percussion system and musical instruments in general.

### SUMMARY OF THE INVENTION

The invention seeks to overcome the above problems and provide a unique and improved resonance isolation system for a musical instrument support. stand. The isolation system includes an improved isolation ring that is convenient and effective at minimizing the transfer of energy from the instrument to the floor.

A resilient isolation ring member is provided for reducing a transfer of energy from a percussion instrument to a support surface supporting a percussion instrument. The isolation ring member comprises a donut-shaped main body having atop surface and a bottom surface; and a central aperture provided in the donut-shaped main body, wherein the central aperture provided in the donut-shaped main body defines an hour-glass opening in the main body. The hour-glass opening is tapered to have a smallest diameter at a central portion of the main body and larger diameters at a top an a bottom of the main body. The invention provides a combination of a support foot for a percussion instrument and a resilient isolation ring member for reducing a transfer of energy from the percussion instrument to a support surface supporting the percussion instrument.

The invention encompasses a variety of different shapes and materials for the isolation ring member.

Other objects and features of the invention are explained with reference to the attached drawings.

### BRIEF DESCRIPTION OF THE DRAWINGS

FIG. 1 is a side view of a prior art high hat stand,

FIG. 2 is prior art arrangement with a reversible rubber/spiked foot member.

FIG. 3 illustrates a further alternate prior art arrangements with a rotatable rubber/spike tip foot member.

FIGS. 4a and 4b illustrate a further alternate prior art arrangement with a retractable rubber/spike tip foot member.

FIG. 4c illustrates an example of a convention spongy rubber floor protector.

FIG. 5 illustrates a top view of the isolation ring of the present invention.

FIG. 6 illustrates a perspective view of the isolation ring of FIG, 5,

FIG. 7 illustrates a cross sectional view of the isolation ring of FIG. 6 taken along line in combination with a resilient foot member having a spike member.

FIG. 8 illustrates a cross sectional view of the isolation ring of FIG. 6 taken along line VII-VII in combination with a resilient foot member having a spike member in a retracted position,

FIG. 9 illustrates a partial perspective view of a percussion stand utilizing the isolation ring member according to an embodiment of the invention.

FIG. 10 illustrates a partial perspective view of a bass drum utilizing the isolation ring member according to an embodiment of the invention,

### DESCRIPTION OF A PREFERRED EMBODIMENT

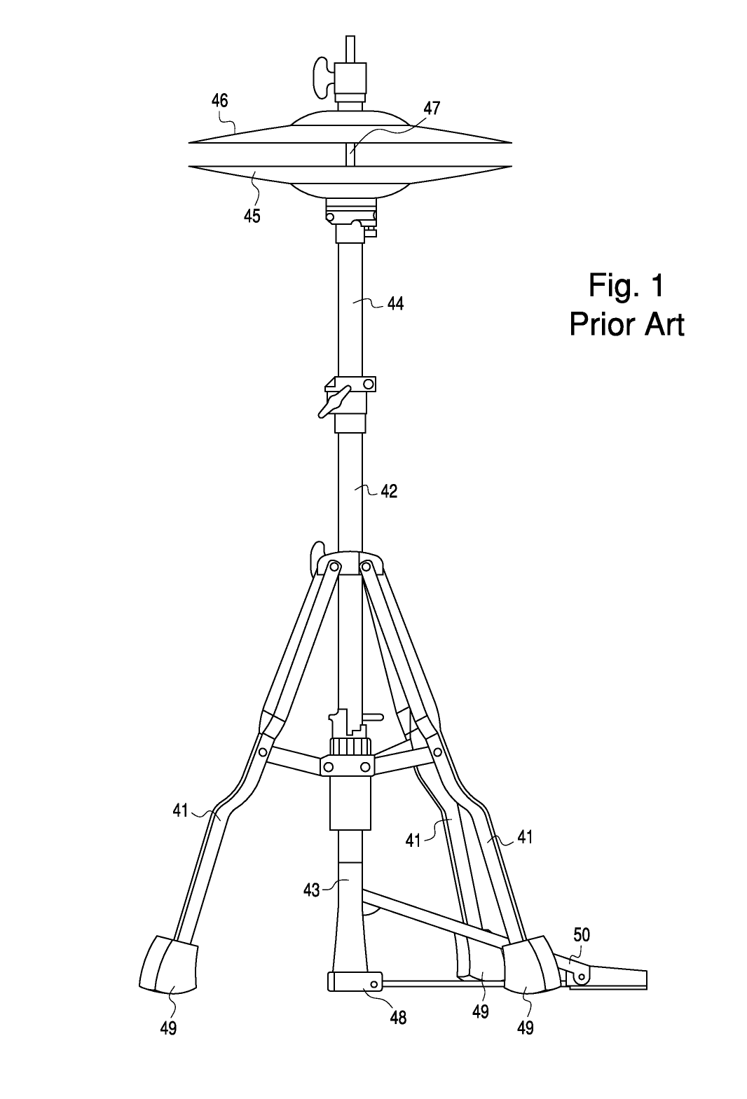

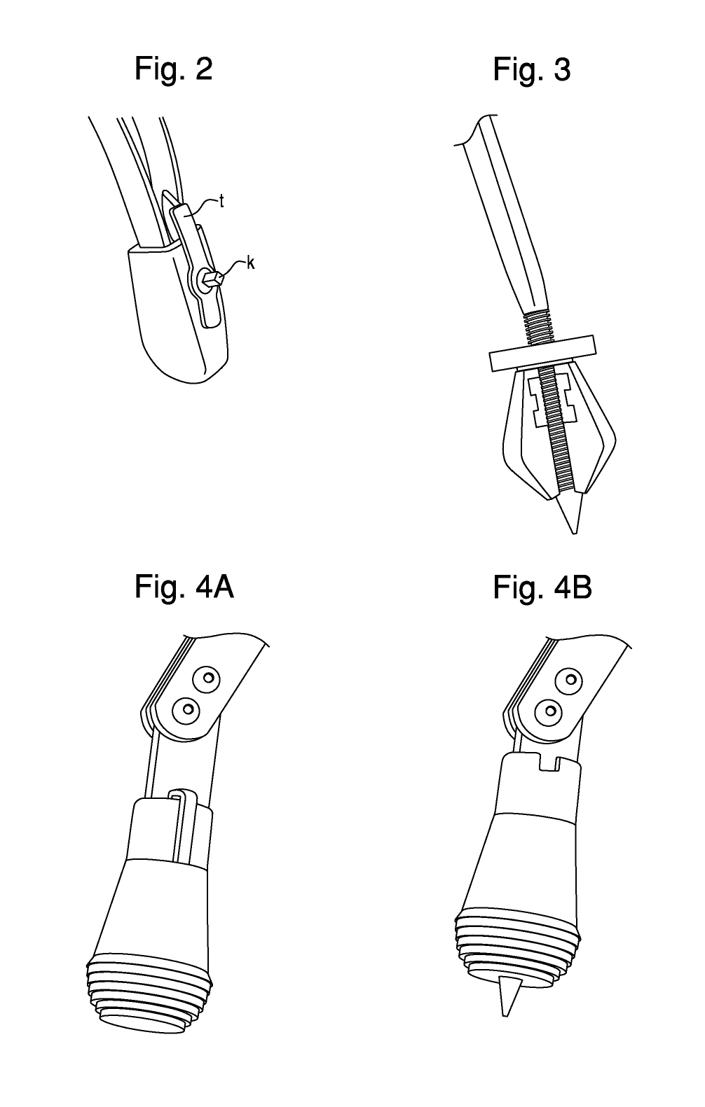

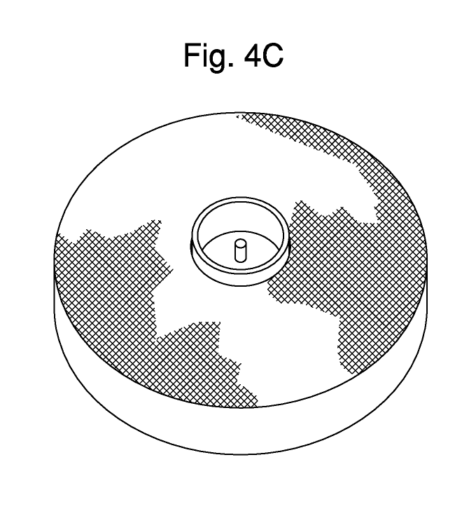

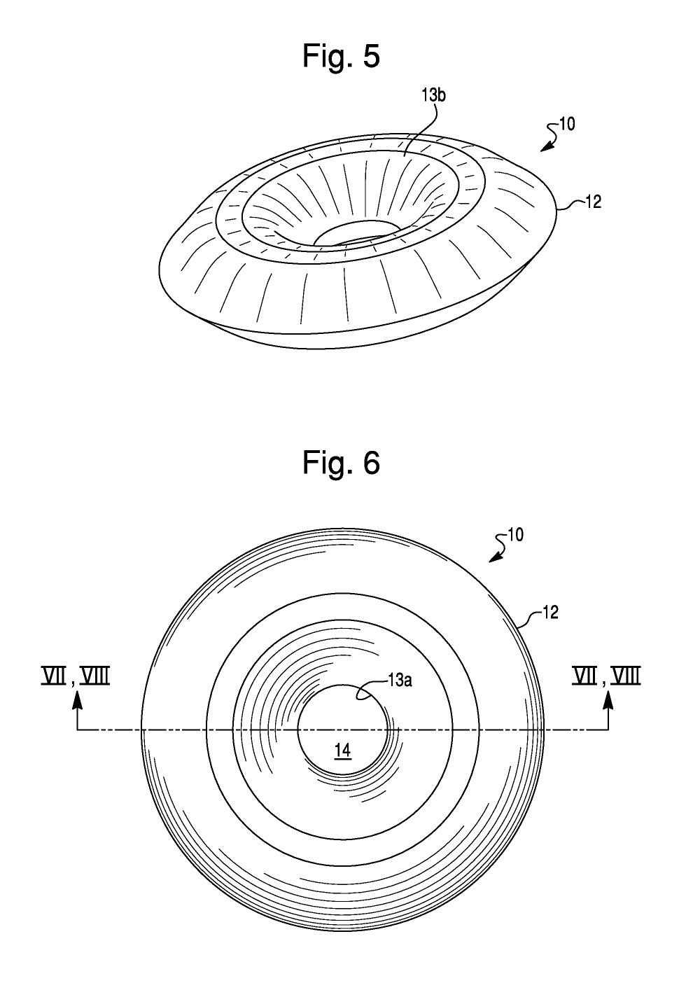

This invention relates to an isolation ring and energy isolation system for a musical instrument, such as a bass drum, high hat stand, etc. The invention may be applied to the cymbal, high hat or other types of musical instrument stands as, for example, shown in FIGS. 1, 9 and 10. This invention is not affected by this configuration or number of legs.

With references to ate drawings, reference numeral 10 generally designates an isolation ring and vibration control assembly constructed in accordance with and embodying a preferred embodiment of the present invention. Isolation ring 10 is a unitary piece of pliable material such as rubber, soft vinyl, or the like, preferably having a circular perimeter 12, a central opening 14 defining an hour-glass shape in cross section, and top and bottom surfaces 16, 18 that are generally planar.

As shown in FIGS. 5 and 6, the resilient isolation ring member 10 reduces a transfer of energy from a percussion instrument to a support surface supporting said percussion instrument by providing an isolation ring member formed with a donut-shaped main body having a top surface and a bottom surface. A central aperture 14 is provided in the donut-shaped main body. The central aperture 14 provided in said donut-shaped main body defines an hour-glass opening in the main body, wherein the hour-glass opening is preferably tapered to have a smallest diameter 13a at a central portion of the main body and larger diameters 13b at a top and a bottom of the main body.

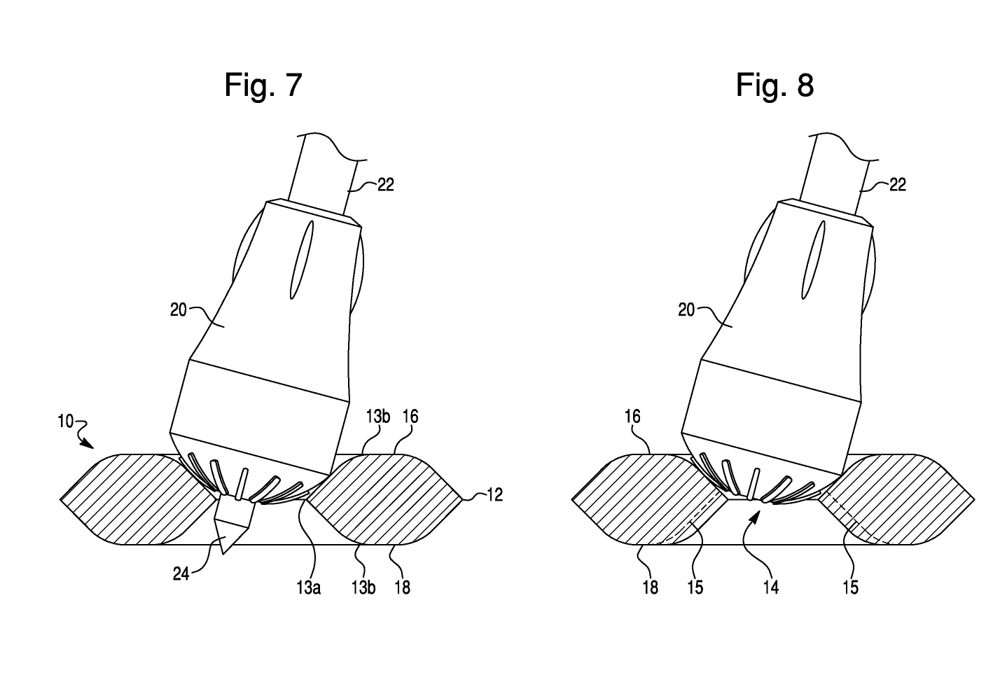

As shown in FIGS. 7 and 8, the present invention provides a combination of a support. foot 20 for a percussion or other instrument and a resilient isolation ring member for reducing a transfer of energy from the percussion instrument to a support surface supporting the percussion instrument. As shown, the combination comprises a resilient foot member 20 affixed to a support leg 22 of percussion instrument; and a ring member 10 including a donut-shaped main body having a top surface 16 and a bottom surface 18; and a central aperture 14 provided in the donut-shaped main body. The central aperture 14 provided in the donut-shaped main body defines an hour-glass opening in the main body. The hour-glass opening is again tapered to have a smallest diameter 13a at a central portion of said main body and larger diameters 13b at a top and a bottom of said main body. The isolation ring 10 is shaped to receive the resilient foot member 20 of an instrument typically having a rounded bottom portion that mates with a top half of the central aperture 14 of the main body 10.

As shown in FIG. 7, the resilient foot member 20 may comprise a spike member 24 extending from the resilient foot member with the spike member 24 passing into the central aperture of the isolation ring 10. The spike member 24 may be retractable or otherwise movable into a non-functioning position (see for example FIG. 8).

With the preferred embodiment, the isolation ring 10 can be disposed beneath preexisting legs a. he instrument, or in an alternative in an “upside down” position, opposite to the position shown in FIG. 7. While the isolation ring 10 shown in the preferred embodiment is illustrated as a symmetric body, it will be understood by those of skill in the art that the top half of the hour-glass opening 14 may be formed to be larger or smaller than the bottom half of the hour-glass opening 14 (as shown by the dotted lines 15 shown in FIG. 8) to permit the isolation ring to fit foot members 20 of different sizes.

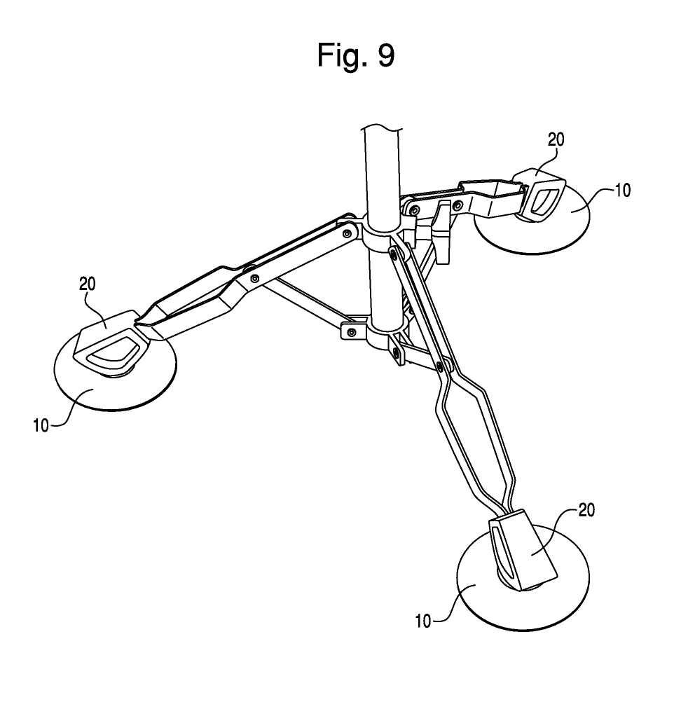

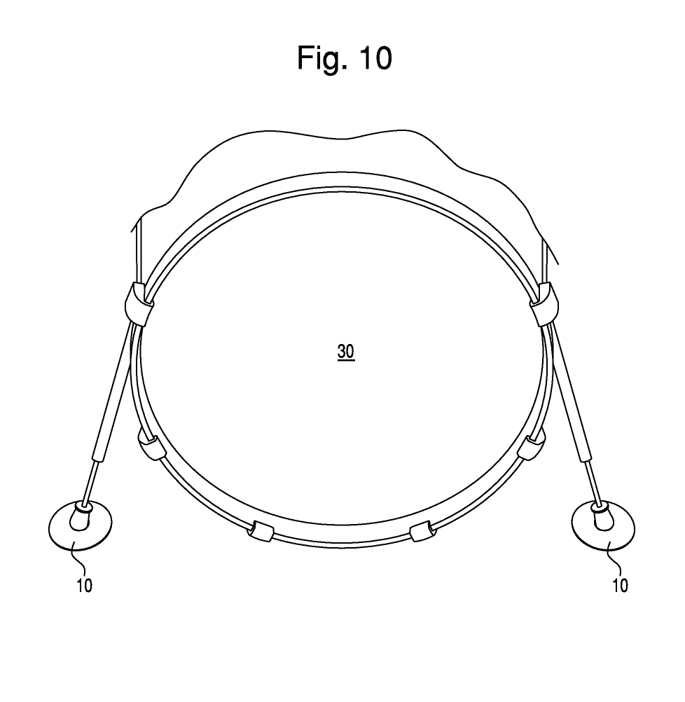

The isolation ring of the invention is not limited to use on a cymbal stand, as in the example shown in FIG. 9. It can be used for a hi-hat stand, a snare drum, bass drums, a chair for a drummer, a drum rack, etc. FIG. 10 illustrates the isolation ring 10 being used to support the legs of a bass drum 30.

Although the present invention has been described in relation to a particular embodiment thereof, many other variations and modifications and other uses will become apparent to those skilled in the art. It is preferred, therefore, that the present invention be limited not by the specific disclosure herein, but only by the appended claims.

1. A resilient isolation ring member for reducing a transfer of energy from a percussion instrument to a support surface supporting said percussion instrument, said isolation ring member comprising:
a donut-shaped main body having a top surface and a bottom surface;
a central aperture provided in said donut-shaped main body;
wherein said central aperture provided in said donut-shaped main body defines an hour-glass opening in said main body, said hour-glass opening being tapered to have a smallest diameter at a central portion of said main body and larger diameters at a top and a bottom of said main body.

2. The ring member according to claim 1, wherein said main body is formed of an elastomeric material.

3. The ring member according to claim 1, wherein said top and bottom surfaces of said main body are planar surfaces.

4. The ring member according to claim 1, wherein said hour-glass opening is symmetric in shape.

5. The ring member according to claim 1, wherein said hour-glass opening is asymmetric in shape.

6. The ring member according to claim 1, wherein at least one of said top surface and said bottom surface is planar.

7. The ring member according to claim 1, wherein both of said top surface and said bottom surface are planar.

8. A combination of a support foot for a percussion instrument and a resilient isolation ring member for reducing a transfer of energy from said percussion instrument to a support surface supporting said percussion instrument, said combination comprising:
a resilient foot member affixed to a support leg of percussion instrument; and
a ring member including a donut-shaped main body having a top surface and a bottom surface; and a central aperture provided in said donut-shaped main body; wherein said central aperture provided in said donut-shaped main body defines an hour-glass opening in said main body, said hour-glass opening being tapered to have a smallest diameter at a central portion of said main body and larger diameters at a top and a bottom of said main body,
wherein said resilient foot member comprises a bottom portion that mates with a top half of said central aperture of said main body above said central portion.

9. The combination according to claim 8, wherein said resilient foot member comprises a spike member extending from said resilient foot member, said spike member passing into said central aperture.

10. The combination according to claim 9, wherein said spike member passes through said central aperture.

11. The combination according to claim 10, wherein said main body is formed of an elastomeric material.

12. The combination according to claim 8, wherein at east one of said top surface and said bottom surface is planar.

13. The combination according to claim 8, wherein both of said top and bottom surfaces of said main body are planar surfaces.

14. The combination according to claim 8, wherein said hour-glass opening is symmetric in shape.

15. The combination according to claim 8, wherein said hour-glass opening is asymmetric in shape.
